(19) United States
(12) Patent Application Publication
(10) Pub. No.: US 2015/0081477 A1
(43) Pub. Date: Mar. 19, 2015

(54) SEARCH QUERY ANALYSIS DEVICE, SEARCH QUERY ANALYSIS METHOD, AND COMPUTER-READABLE RECORDING MEDIUM

(71) Applicant: NEC Corporation, Minato-ku, Tokyo (JP)

(72) Inventors: Takao Shime, Tokyo (JP); Daishi Kato, Tokyo (JP); Satoru Ooga, Tokyo (JP)

(21) Appl. No.: 14/390,927

(22) PCT Filed: Apr. 18, 2013
(86) PCT No.: PCT/JP2013/061498

§ 371 Date: Oct. 6, 2014

(30) Foreign Application Priority Data
Apr. 20, 2012 (JP) 2012-096400

(51) Int. Cl. G06Q 30/06; G06F 17/30

(52) U.S. Cl. CPC G06Q 30/0627; G06F 17/30867; G06F 17/30598; G06F 17/30876
USPC 705/26.63

(57) ABSTRACT

A search query analysis device (1) according to the present invention is provided with a search query sorting unit (13) that sorts a plurality of search queries input by a user into a plurality of search query groups in chronological order, and specifies a purchase search query group that includes a search query input immediately before a product purchase of the user and first search query groups input before the purchase search query group, among the plurality of search query groups, a keyword extraction unit (12) that extracts a keyword group from a description of a purchased product purchased by the user, and a search query group extraction unit (14) that computes a similarity between the first search query groups and the keyword group, and extracts a first search query group whose similarity is less than a threshold.

### TECHNICAL FIELD

The present invention relates to a search query analysis device and a search query analysis method that enable search queries to be analyzed in order to uncover new applications of a given product, and a computer-readable recording medium storing a computer program for realizing the device and method.

### BACKGROUND ART

An increasing number of users are utilizing EC (electronic commerce) sites or electronic shopping malls to purchase products following the popularization of the Internet in recent years. With such use of EC sites and the like to purchase products, or so-called online shopping, it is easy to find products using a search system, and thus the purchase of products through online shopping is expected to further increase from now on.

In order to make it easier for a user to be able to search for a product that he or she is looking for with online shopping, a system disclosed in Patent Document 1, for example, recommends another search query related to the search query input by the user. Using this other recommended search query, even a user with a poor search technique can easily search for products that he or she wants.

With such online shopping through EC sites and the like, the user goes through the following steps, for example, to purchase a product. First, the user inputs the brand name or the like of the product that he or she wishes to purchase as a search query. The search system presents the user with products related to this input search query, and if the user likes one of products that are presented, he or she purchases that product.

Incidentally, in order to look for products suitable for a given application, the user sometimes inputs the application as a search query, rather than a brand name or the like. In this case, a typical search system extracts products whose description includes the application input by the user, and these extracted products are presented to the user. If one of the extracted products is suitable for the application that the user is looking for, the user purchases that product.

### CITATION LIST

### Patent Document

Patent Document 1: JP 2008-544377A

### DISCLOSURE OF THE INVENTION

### Problem to be Solved by the Invention

However, only applications envisaged by the manufacturer, retailer or the like of each product are included in the description of the product. Thus, even if a product could be used for the application that the user is looking for, a typical search system is not able to present that product to the user if the applications included in the description of that product differs from the application that the user is looking for. Since potential customers may, as a result, be overlooked with a typical search system, uncovering new applications of products is also important in order to gain potential customers.

In view of this, an exemplary object of the present invention is to provide a search query analysis device, a search query analysis method, and a computer-readable recording medium that enable search queries to be analyzed in order to uncover new applications of a given product.

### Means for Solving the Problem

In order to attain the above object, a search query analysis device according to one aspect of the present invention includes a search query sorting unit that sorts a plurality of search queries input by a user into a plurality of search query groups in chronological order, and specifies a purchase search query group that includes a search query input immediately before a product purchase of the user and first search query groups input before the purchase search query group, among the plurality of search query groups, a keyword extraction unit that extracts a keyword group from a description of a purchased product purchased by the user, and a search query group extraction unit that computes a similarity between the first search query groups and the keyword group extracted by the keyword extraction unit, and extracts a first search query group whose similarity is less than a threshold.

Also, in order to attain the above object, a search query analysis method according to one aspect of the present invention includes the steps of (a) sorting a plurality of search queries input by a user into a plurality of search query groups in chronological order, and specifying a purchase search query group that includes a search query input immediately before a product purchase of the user and first search query groups input before the purchase search query group, among the plurality of search query groups, (b) extracting a keyword group from a description of a purchased product purchased by the user, and (c) computing a similarity between the first search query groups and the keyword group extracted in the step (b), and extracting a first search query group whose similarity is less than a threshold.

Furthermore, in order to attain the above object, a computer-readable recording medium according to one aspect of the present invention is a computer-readable recording medium storing a computer program for analyzing, by computer, a search query input by a user, the computer program including commands for causing the computer to execute the steps of (a) sorting a plurality of search queries input by a user into a plurality of search query groups in chronological order, and specifying a purchase search query group that includes a search query input immediately before a product purchase of the user and first search query groups input before the purchase search query group, among the plurality of search query groups, (b) extracting a keyword group from a description of a purchased product purchased by the user, and (c) computing a similarity between the first search query groups and the keyword group extracted in the step (b), and extracting a first search query group whose similarity is less than a threshold.

### Effects of the Invention

As mentioned above, according to the present invention, search queries can be analyzed in order to uncover new applications of a product.

### BRIEF DESCRIPTION OF DRAWINGS

FIG. 1 is a block diagram showing a configuration of a search query analysis device according to an embodiment of the present invention.

FIG. 2 is a flowchart showing operations of the search query analysis device according to an embodiment of the present invention.

FIG. 3 is a diagram showing an example of search query information that is stored by an information storage unit according to an embodiment of the present invention.

FIG. 4 is a diagram showing an example of purchase information that is stored by the information storage unit according to an embodiment of the present invention.

FIG. 5 is a diagram showing an example of search query group information sorted by a search query sorting unit according to an embodiment of the present invention.

FIG. 6 is a diagram showing an example of various information that is acquired by a search query group extraction unit according to an embodiment of the present invention.

FIG. 7 is a diagram showing an example of various information that is acquired by a search query group distinguishing unit according to an embodiment of the present invention.

FIG. 8 is a diagram showing an example of various information that is acquired by the search query group distinguishing unit according to an embodiment of the present invention.

FIG. 9 is a block diagram showing the configuration of a computer that realizes the search query analysis device according to an embodiment of the present invention.

### DESCRIPTION OF EMBODIMENTS

### Embodiments

Hereinafter, a search query analysis device, a search query analysis method and a computer program according to embodiments of the present invention will be described, with reference to the drawings.

### Search Query Analysis Device

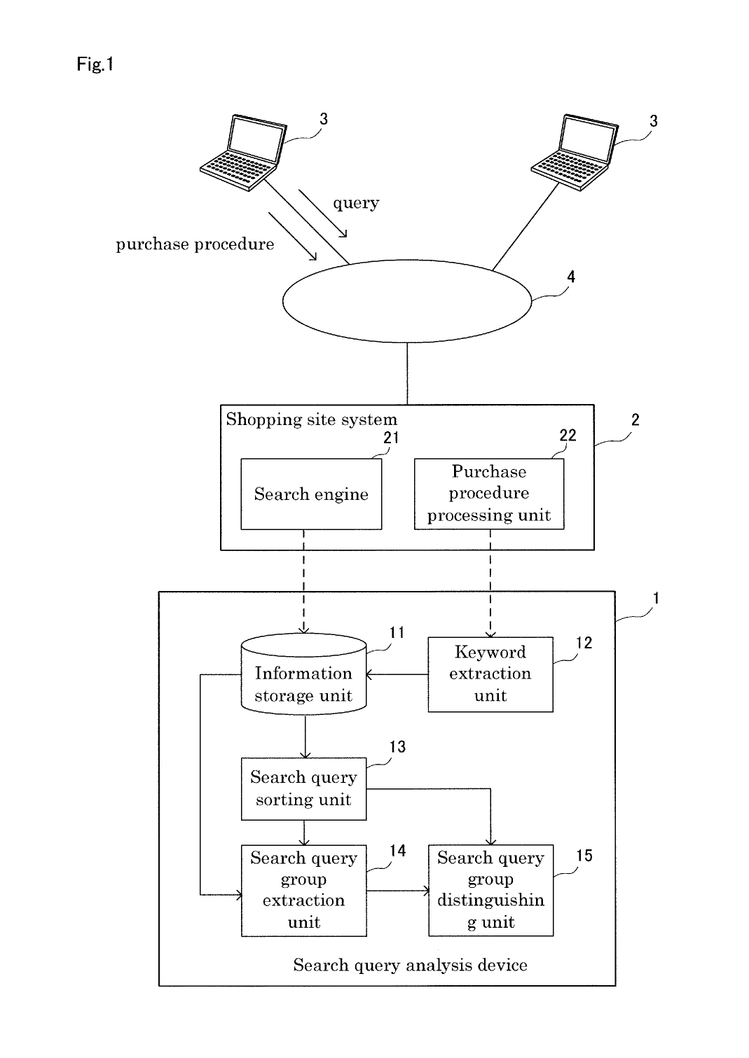

Initially, the configuration of a search query analysis device according to the present embodiment will be described using FIG. 1. FIG. 1 is a block diagram showing the configuration of the search query analysis device according to an embodiment of the present invention.

As shown in FIG. 1, in the present embodiment, a search query analysis device 1 is connected to a shopping site system 2 such as an EC (electronic commerce) site system or an electronic shopping mall system. The search query analysis device 1 analyzes search queries input from terminal devices 3 connected to the shopping site system 2 via a network 4 such as the Internet. The search query analysis device 1 according to the present embodiment is provided with a search query sorting unit 13, a keyword extraction unit 12, and a search query group extraction unit 14.

The search query sorting unit 13 sorts a plurality of search queries input by a user into a plurality of search query groups in chronological order. The search query sorting unit 13 then specifies a purchase search query group that includes the search query input immediately before the user's product purchase and first search query groups input before the purchase search query group, among the plurality of sorted search query groups.

The keyword extraction unit 12 extracts a keyword group from the description of the purchased product purchased by the user.

The search query group extraction unit 14 computes the similarity between the first search query groups and the keyword group, and extracts a first search query group whose similarity is less than a threshold.

According to the above search query analysis device 1, a first search query group whose similarity to a keyword group is low can be extracted. Since this extracted first search query group has low similarity to the keyword group contained in the description of the purchased product, it can be regarded as a candidate for a new application that is not contained in the description of the purchased product. In this way, the search query analysis device 1 according to the present embodiment is able to analyze search queries in order to uncover new applications of the purchased product.

Here, the configuration of the search query analysis device 1 will be described more specifically. As shown in FIG. 1, in the present embodiment, the search query analysis device 1 is further provided with an information storage unit 11 and a search query group distinguishing unit 15, in addition to the search query sorting unit 13, the keyword extraction unit 12 and the search query group extraction unit 14.

The shopping site system 2 is provided with a search engine 21 and a purchase procedure processing unit 22.

The search engine 21 searches for a product based on a search query received from the terminal device 3 connected via the network 4. Also, the search engine 21 stores search query information in the information storage unit 11 for every search event. Note that the search query information includes user information specifying the user who performed the search, search date-time information and a search query.

The purchase procedure processing unit 22 executes purchase procedure processing when the user purchases a product from among the retrieved products.

When the purchase procedure processing unit 22 executes purchase procedure processing, the keyword extraction unit 12 detects the purchase event, and acquires the user information of the user who made the purchase and the purchase date-time information. Also, the keyword extraction unit 12 extracts a keyword group consisting of a plurality of keywords from the description of the product on the Web page on which the purchased product appears.

The keyword extraction unit 12 stores purchase information in the information storage unit 11. Note that this purchase information includes user information specifying the user who purchased the product, purchase date-time information and a keyword group.

The information storage unit 11 stores the search query information from the search engine 21 and the purchase information from the keyword extraction unit 12.

The search query sorting unit 13, in the present embodiment, acquires the search query information and the purchase information that are stored in the information storage unit 11. The search query sorting unit 13 then, for each user, computes the similarity between the search queries in chronological order, and sorts the search queries into a plurality of search query groups based on this similarity.

Also, the search query sorting unit 13 specifies a purchase search query group input immediately before the user's product purchase and first search query groups input before this purchase search query group, from among the plurality of search query groups.

The search query group extraction unit 14, in the present embodiment, acquires the first search query groups from the search query sorting unit 13, and acquires the purchase information from the information storage unit 11. The search query group extraction unit 14 then computes the similarity between the first search query groups and the keyword group, and extracts a first search query group whose similarity is less than a threshold.

The search query group distinguishing unit 15 acquires the first search query group extracted by the search query group extraction unit 14 from the search query group extraction unit 14, and distinguishes this acquired first search query group as being a target search query group or a non-target search query group. Note that “target search query group” refers to a search query group directed to searching for the purchased product among the first search query groups, and “non-target search query group” refers to a search query group not directed to searching for the purchased product among the first search query groups.

Also, the search group distinguishing unit 15, in the case where the first search query group is the target search query group, notifies the first search query group to the retailer of the purchased product, the administrator of the shopping site system 2 or the like as a new application of the purchased product.

### Operations of Search Query Analysis Device

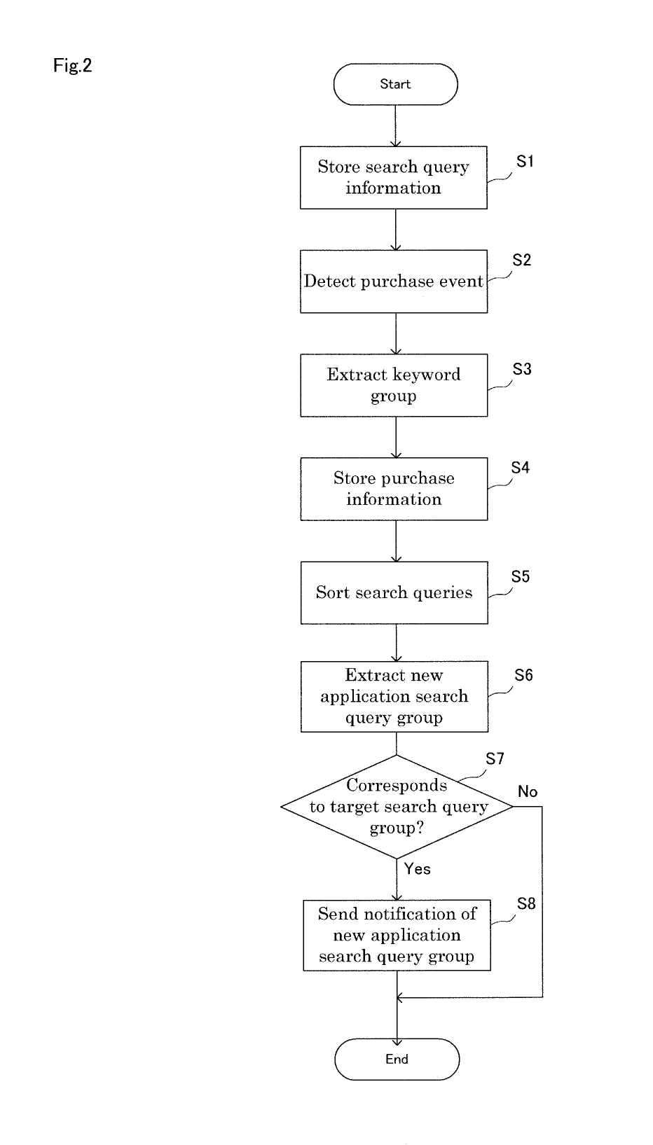

Next, the operations of the search query analysis device according to an embodiment of the present invention will be described using FIG. 2, while taking FIG. 1 into consideration as appropriate. Note that, in the present embodiment, since the search query analysis method is implemented by operating the search query analysis device 1, the following description of the operations of the search query analysis device is given in place of description of the search query analysis method according to the present embodiment.

FIG. 2 is a flowchart showing operation procedures of the search query analysis device according to an embodiment of the present invention.

First, the terminal device 3, upon receiving input of a search query that apparently refers to an application in order to look for a product suitable for a certain application, transmits the search query to the search engine 21 via the network 4. The search engine 21 executes product search processing based on this search query. The search engine 21 then transmits the search query to the information storage unit 11 as search query information together with user information and search date-time information, every time there is such a search event.

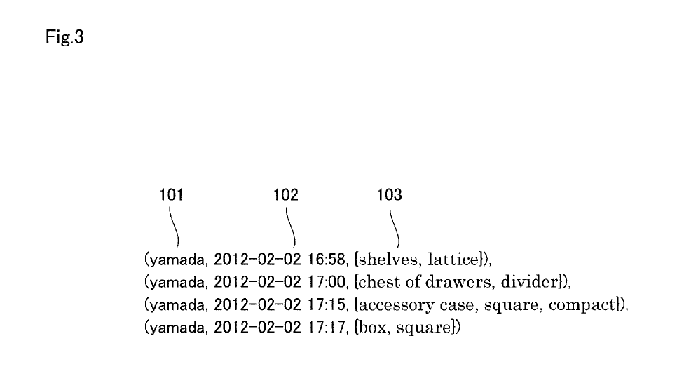

As shown in FIG. 2, the information storage unit 11 stores the search query information received from the search engine 21 (step S1). Note that the search query information that is stored in the information storage unit 11 includes, for example, user information 101, search date-time information 102, and a search query 103, as shown in FIG. 3. FIG. 3 is a diagram showing an example of search query information that is stored in the information storage unit 11 according to an embodiment of the present invention.

When the user purchases a product from among the products presented as search results in the shopping site system 2, the purchase procedure processing unit 22 of the shopping site system 2 executes purchase procedure processing. The keyword extraction unit 12 of the search query analysis device 1 then detects that purchase event (step S2).

Also, whenever a purchase event is detected, the keyword extraction unit 12 acquires user information and purchase date-time information relating to the purchase event, and extracts a keyword group from the description of the purchased product (step S3). For example, the keyword extraction unit 12 is able to extract keywords by acquiring the description of the purchased product that appears on the Web page, and perform morphological analysis on this description.

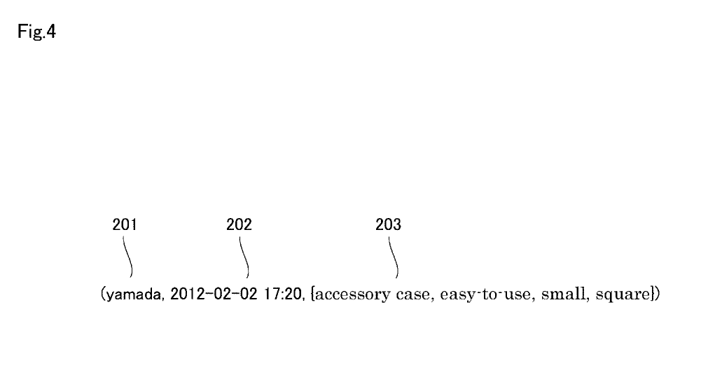

The keyword extraction unit 12 then stores purchase information including the user information, the purchase date-time information and the keyword group in the information storage unit 11 (step S4). Note that the purchase information that is stored in the information storage unit 11 includes user information 201, purchase date-time information 202 and keyword group 203, as shown in FIG. 4. FIG. 4 is a diagram showing an example of purchase information that is stored in the information storage unit 11 according to an embodiment of the present invention.

The processing of the above steps S1 to S4 is repeatedly executed for a preset period, and search query information and purchase information are thereby stored in the information storage unit 11.

Once storing of search query information and purchase information has been performed for a predetermined period, next the search query sorting unit 13 sorts the search queries stored in the information storage unit 11 into a plurality of search query groups (step S5).

Specifically, first, the search query sorting unit 13 acquires the search query information and the purchase information that are stored in the information storage unit 11. The search query sorting unit 13 then sorts the search queries into a plurality of search query groups in chronological order for each user, based on the user information and search date-time information associated with the search queries. Specifically, the search query sorting unit 13 computes the similarity between the search queries in chronological order, and separates the search queries at the point at which this similarity falls to less than or equal to a threshold. That is, the search query sorting unit 13 collects similar search queries among the search queries arranged in chronological order as one search query group.

For example, in the case where search query information such as shown in FIG. 3 is acquired, the search query sorting unit 13 computes the similarity between the search query that is at the top, and the search query that is second from the top. The search query sorting unit 13 then judges that this similarity exceeds the threshold, and collects the search query that is at the top and the search query that is second from the top as one search query group.

Similarly, the search query sorting unit 13 computes the similarity between the search query that is second from the top and the search query that is third from the top. The search query sorting unit 13 then judges that this similarity is less than or equal to the threshold, and sorts the search query that is second from the top and the search query that is third from the top into different search query groups.

Next, the search query sorting unit 13 computes the similarity between the search query that is third from the top and the search query that is fourth from the top. The search query sorting unit 13 judges that this similarity exceeds the threshold, and collects the search query that is third from the top and the search query that is fourth from the top as one search query group. As described above, the search query sorting unit 13 sorts the search queries in search query information such as shown in FIG. 3 into two search query groups.

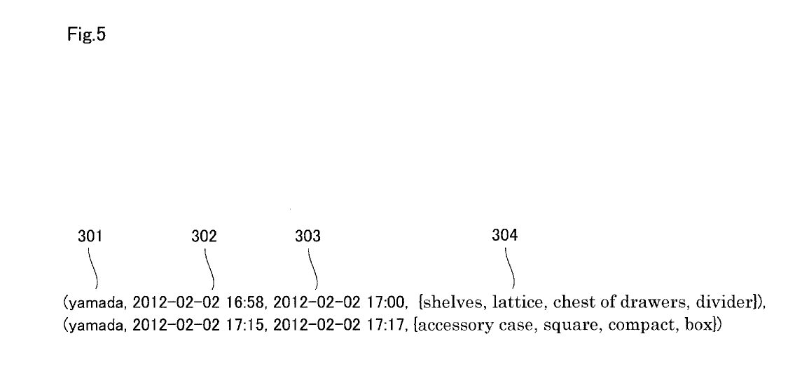

Search query groups 30 thus sorted by the search query sorting unit 13 are, as shown in FIG. 5, associated with user information 301, a search start date-time 302, and a search end date-time 303. Note that FIG. 5 is a diagram showing exemplary search query group information sorted by the search query sorting unit 13 according to an embodiment of the present invention.

Note that as the method of computing the similarity between search queries, the similarity can be computed based on the number of Web pages that are included in both search results, as a result of searches performed using search queries that are adjacent in chronological order, for example.

Also, the search query sorting unit 13 specifies a purchase search query group that includes the search query input immediately before the user purchased the product and first search query groups input before the purchase search query group, among the sorted search query groups.

For example, the search query sorting unit 13 acquires the purchase information shown in FIG. 4, and, based on the purchase date-time information 202 in this purchase information, specifies the search query group that is second from the top in FIG. 5 as the purchase search query group, and specifies the search query group that is at the top in FIG. 5 as a first search query group.

Next, the search query group extraction unit 14 extracts a first search query group to serve as a candidate for a new application of the purchased product (hereinafter “new application candidate query group”), from the first search query groups specified by the search query sorting unit 13 (step S6).

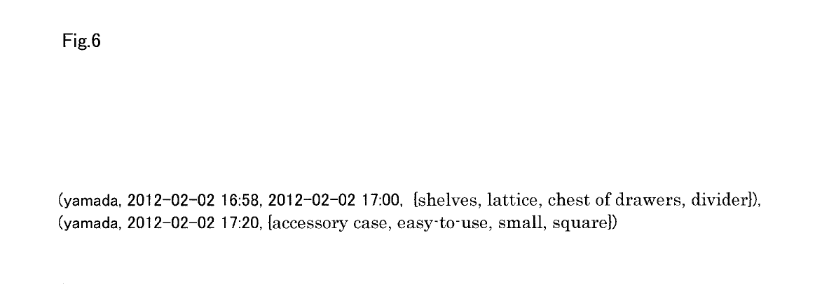

Specifically, the search query group extraction unit 14 acquires various information such as shown in FIG. 6. That is, the search query group extraction unit 14 acquires first search query group information from the search query sorting unit 13, and acquires purchase information from the information storage unit 11. FIG. 6 shows an example of various information that is acquired by the search query group extraction unit according to an embodiment of the present invention, the information that is at the top being first search query group information, and the information that is second from the top being purchase information.

Next, the search query group extraction unit 14 computes the similarity between the first search query groups and the keyword group extracted at step S3. The search query group extraction unit 14 then extracts a first search query group whose similarity to the keyword group is less than or equal to a threshold as a candidate for a new application of the purchased product, that is, as a new application candidate query group.

Note that in the case where there are a plurality of first search query groups, the search query group extraction unit 14 computes the similarity to the keyword group sequentially from the first search query group whose search date-time is closest to the purchase date-time.

The search query group extraction unit 14 is able to compute the similarity between a first search query group and the keyword group as follows, for example.

First, the search query group extraction unit 14 generates a keyword vector using a TF-IDF value, from the keywords constituting the first search query group. Similarly, the search query group extraction unit 14 generates a keyword vector using a TF-IDF value, from each keyword constituting the keyword group extracted at step S3. The search query group extraction unit 14 is then able to compute the similarity between the first search query group and the keyword group, by computing the inner product of the generated keyword vectors.

Next, the search query group distinguishing unit 15 acquires the first search query group (new application candidate query group) to serve as a candidate for a new application from the search query group extraction unit 14, and determines whether this new application candidate query group is a target search query group directed to searching for the purchased product (step S7).

This search query group distinguishing unit 15 is able to distinguish the new application candidate query group as being a target search query group directed to searching for the purchased product or a non-target search query group not directed to searching for the purchased product, with the following method, for example.

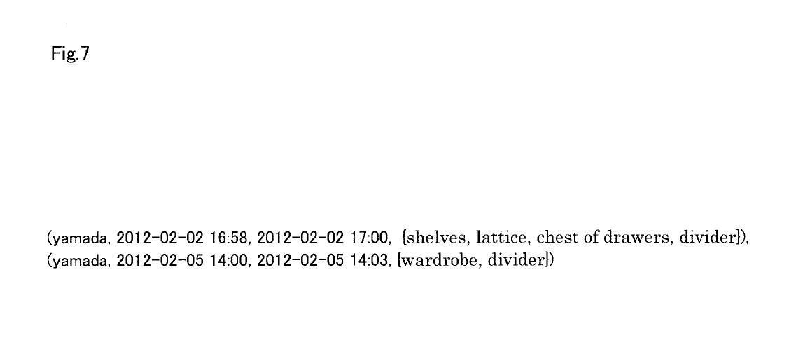

For example, the search query group distinguishing unit 15 acquires various information such as shown in FIG. 7. That is, the search query group distinguishing unit 15 acquires information on the new application candidate query group extracted by the search query group extraction unit 14. Also, the search query group distinguishing unit 15 acquires information on a second search query group from the search query sorting unit 13. FIG. 7 is a diagram showing an example of the various information that is acquired by the search query group distinguishing unit according to an embodiment of the present invention, the information that is at the top being information on the new application candidate query group, and the information that is second from the top being information on the second search query group. Also, “second search query group” refers to a search query group input after the purchase search query group, among the search query groups sorted by the search query sorting unit 13.

The search query group distinguishing unit 15 then determines whether the new application candidate query group acquired as a candidate for a new application is similar to the second search query group. This similarity determination can be performed by, for example, generating a keyword vector for each of the search query groups, and deriving the similarity from the inner product of the keyword vectors, as described above.

In the case where the above similarity exceeds the threshold, the search query group distinguishing unit 15 determines that the first search query group and the second search query group are similar, and specifies that this new application candidate query group that is similar to the second search query group is a non-target search query group (No at step S7). That is, search queries input by the same user after the product purchase are highly likely to not be search queries input for the purpose of searching for the purchased product. It can thus be assumed that a new application candidate query group that is similar to a second search query group input after the product purchase is a non-target search query group.

The search query group distinguishing unit 15 is alternatively able to distinguish the new application candidate query group as being a target search query group or a non-target search query group with the following method.

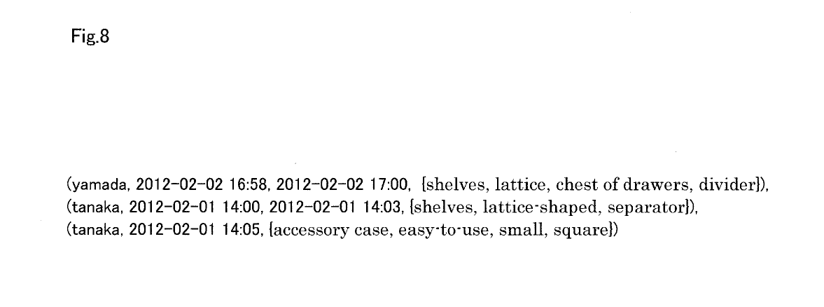

First, the search query group distinguishing unit 15 acquires various information such as shown in FIG. 8. That is, the search query group distinguishing unit 15 acquires the new application candidate query group extracted by the search query group extraction unit 14. Also, the search query group distinguishing unit 15 acquires a purchase search query group used when another user purchased another product from the search query sorting unit 13. FIG. 8 is a diagram showing an example of information that is acquired by the search query group distinguishing unit according to an embodiment of the present invention, with the information that is at the top being information on the new application candidate query group, the information that is second from the top being information on a purchase search query group and the information that is third from the top being purchase information.

The search query group distinguishing unit 15 then computes the similarity between the purchase search query group of the other user and the new application candidate query group serving as a candidate for a new application. Note that the same method of computing the similarity as the method described above can be used in this case. The search query group distinguishing unit 15 judges that the new application candidate query group is a non-target search query group, in the case where this computed similarity exceeds a threshold (No at step S7).

When the search query group distinguishing unit 15 judges that the new application candidate query group is not a target search query group by methods such as described above (No at step S7), the search query analysis device 1 ends the application uncovering processing with respect to the target purchased product of the target user.

On the other hand, the search query group distinguishing unit 15, upon having judged that the new application candidate query group is a target search query group (Yes at step S7), notifies the retailer of the purchased product, the administrator of the shopping site system 2 or the like that this new application candidate query group is a new application of the purchased product (step S8).

In the case where other purchase information is also stored in the information storage unit 11, the search query analysis device 1 executes the processing of steps S5 to S8 for every purchased product to uncover new applications. Also, in the case where the search query group information and purchase information for a plurality of users are stored in the information storage unit 11, the search query analysis device 1 executes the processing of steps S5 to S8 for every purchased product of each user to uncover new applications.

### Computer Program

A computer program according to an embodiment of the present invention can be a computer program that causes a computer to perform steps S1 to S8. The search query analysis device and the search query analysis method according to the present embodiment can be realized by installing this computer program in a computer and executing the installed computer program. In this case, a CPU (Central Processing Unit) of the computer functions and performs processing as the search query sorting unit 13, the search query group extraction unit 14, the keyword extraction unit 12 and the search query group distinguishing unit 15.

The first search query group (target search query group) that is ultimately extracted according to the present embodiment as described above is a search query group directed to searching for the purchased product, despite not being similar to the keyword group extracted from the description of the purchased product. This first search query group (target search query group) can thus be regarded as a new application of the product purchased by the user. Therefore, the present embodiment enables a new application of the purchased product to be uncovered.

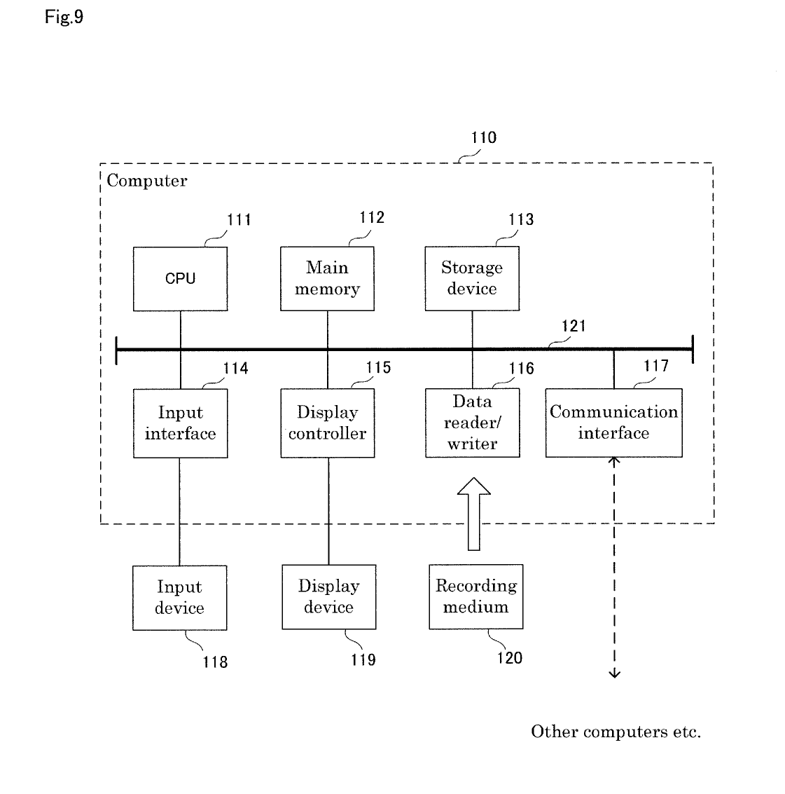

Here, a computer that realizes the search query analysis device 1 by executing the computer program according to the embodiment will be described using FIG. 9. FIG. 9 is a block diagram showing an example of a computer that realizes the search query analysis device 1 according to an embodiment of the present invention.

As shown in FIG. 9, the computer 110 is provided with a CPU 111, a main memory 112, a storage device 113, an input interface 114, a display controller 115, a data reader/writer 116, and a communication interface 117. These constituent elements are connected to each other via a bus 121 in a manner that enables data communication.

The CPU 111 implements various operations by expanding the computer program (codes) according to the present embodiment stored in the storage device 113 in the main memory 112, and executing these codes in a predetermined order. The main memory 112 is, typically, a volatile storage device such as DRAM (Dynamic Random Access Memory). Also, the computer program according to the present embodiment is provided in a state of being stored on a computer-readable recording medium 120. Note that the computer program according to the present embodiment may also be circulated on the Internet connected via the communication interface 117.

Also, apart from a hard disk, specific examples of the storage device 113 include a semiconductor memory device such as a flash memory. The input interface 114 mediates data communication between the CPU 111 and an input device 118 such as a keyboard and a mouse. The display controller 115 is connected to a display device 119 and controls display on the display device 119. The data reader/writer 116 mediates data communication between the CPU 111 and the recording medium 120, and executes reading out of the computer program from the recording medium 120, and writing of the results of processing by the computer 110 to the recording medium 120. The communication interface 117 mediates data communication between the CPU 111 and other computers.

Also, specific examples of the recording medium 120 include general-purpose semiconductor memory devices such as CF (Compact Flash (registered trademark)) and SD (Secure Digital), magnetic storage media such as a flexible disk (Flexible Disk) and optical storage media such as CD-ROM (Compact Disk Read Only Memory).

Although embodiments of the present invention have been described above, the invention is not limited to these embodiments, and various modifications can be made without deviating from the gist of the invention.

For example, in the search query analysis device 1, the search query group distinguishing unit 15 may further have a function of extracting the user information of a user who has input at least a predetermined number of first search query groups that were distinguished as being the target search query group, and specifying this user as a lead user. Note that “lead user” in this specification refers to a user who devises a way of using an existing product to serve his or her purpose if a product that can directly serve his or her purpose is not available.

Also, the abovementioned embodiments can be partially or wholly represented by supplementary notes 1 to 21 described below, but are not limited to the following description.

### Supplementary Note 1

A search query analysis device includes a search query sorting unit that sorts a plurality of search queries input by a user into a plurality of search query groups in chronological order, and specifies a purchase search query group that includes a search query input immediately before a product purchase of the user and first search query groups input before the purchase search query group, among the plurality of search query groups, a keyword extraction unit that extracts a keyword group from a description of a purchased product purchased by the user, and a search query group extraction unit that computes a similarity between the first search query groups and the keyword group extracted by the keyword extraction unit, and extracts a first search query group whose similarity is less than a threshold.

### Supplementary Note 2

With the search query analysis device according to supplementary note 1, the search query sorting unit sorts the plurality of search queries into the plurality of search query groups based on a similarity between the search queries.

### Supplementary Note 3

The search query analysis device according to supplementary note 1 further includes a search query group distinguishing unit for distinguishing the first search query group extracted by the search query group extraction unit as being a target search query group directed to searching for the purchased product or a non-target search query group not directed to searching for the purchased product.

### Supplementary Note 4

With the search query analysis device according to supplementary note 3, the search query group distinguishing unit computes a similarity between the first search query group extracted by the search query group extraction unit and a second search query group input after the purchase search query group, and judges the first search query group to be the non-target search query group if the similarity is greater than a threshold.

### Supplementary Note 5

With the search query analysis device according to supplementary note 3, the search query group distinguishing unit computes a similarity between the first search query group extracted by the search query group extraction unit and a purchase search query group used when another product different from the purchased product was purchased by another user different from the user, and judges that the first search query group is the non-target search query group if the similarity is greater than or equal to a threshold.

### Supplementary Note 6

With the search query analysis device according to supplementary note 3, the search query group distinguishing unit extracts user information of a user who has input at least a predetermined number of first search query groups that were distinguished as being the target search query group.

### Supplementary Note 7

With the search query analysis device according to supplementary note 1, the search query group extraction unit, in a case where there are a plurality of first search query groups, computes the similarity to the keyword group sequentially from the first search query group whose search date-time is closest to a purchase date-time.

### Supplementary Note 8

A search query analysis method includes the steps of (a) sorting a plurality of search queries input by a user into a plurality of search query groups in chronological order, and specifying a purchase search query group that includes a search query input immediately before a product purchase of the user and first search query groups input before the purchase search query group, among the plurality of search query groups, (b) extracting a keyword group from a description of a purchased product purchased by the user, and (c) computing a similarity between the first search query groups and the keyword group extracted in the step (b), and extracting a first search query group whose similarity is less than a threshold.

### Supplementary Note 9

With the search query analysis method according to supplementary note 8, in the step (a), the plurality of search queries are sorted into the plurality of search query groups based on a similarity between the search queries.

### Supplementary Note 10

The search query analysis method according to supplementary note 8 further includes the step of (d) distinguishing the first search query group extracted in the step (c) as being a target search query group directed to searching for the purchased product or a non-target search query group not directed to searching for the purchased product.

### Supplementary Note 11

With the search query analysis method according to supplementary note 10, in the step (d), a similarity between the first search query group extracted in the step (c) and a second search query group input after the purchase search query group is computed, and the first search query group is judged to be the non-target search query group if the similarity is greater than a threshold.

### Supplementary Note 12

With the search query analysis method according to supplementary note 10, in the step (d), a similarity between the first search query group extracted in the step (c) and a purchase search query group used when another product different from the purchased product was purchased by another user different from the user is computed, and the first search query group is judged to be the non-target search query group if the similarity is greater than or equal to a threshold.

### Supplementary Note 13

With the search query analysis method according to supplementary note 10, in the step (d), user information of a user who has input at least a predetermined number of first search query groups that were distinguished as being the target search query group is extracted.

### Supplementary Note 14

With the search query analysis method according to supplementary note 8, in the step (c), in a case where there are a plurality of first search query groups, the similarity to the keyword group is computed sequentially from the first search query group whose search date-time is closest to a purchase date-time.

### Supplementary Note 15

A computer-readable recording medium stores a computer program for analyzing, by computer, a search query input by a user, the computer program including commands for causing the computer to execute the steps of (a) sorting a plurality of search queries input by a user into a plurality of search query groups in chronological order, and specifying a purchase search query group that includes a search query input immediately before a product purchase of the user and first search query groups input before the purchase search query group, among the plurality of search query groups, (b) extracting a keyword group from a description of a purchased product purchased by the user, and (c) computing a similarity between the first search query groups and the keyword group extracted in the step (b), and extracting a first search query group whose similarity is less than a threshold.

### Supplementary Note 16

With the computer-readable recording medium according to supplementary note 15, in the step (a), the plurality of search queries are sorted into the plurality of search query groups based on a similarity between the search queries.

### Supplementary Note 17

With the computer-readable recording medium according to supplementary note 15, the computer program further includes a command for causing the computer to execute the step of (d) distinguishing the first search query group extracted in the step (c) as being a target search query group directed to searching for the purchased product or a non-target search query group not directed to searching for the purchased product.

### Supplementary Note 18

With the computer-readable recording medium according to supplementary note 17, in the step (d), a similarity between the first search query group extracted in the step (c) and a second search query group input after the purchase search query group is computed, and the first search query group is judged to be the non-target search query group if the similarity is greater than a threshold.

### Supplementary Note 19

With the computer-readable recording medium according to supplementary note 17, in the step (d), a similarity between the first search query group extracted in the step (c) and a purchase search query group used when another product different from the purchased product was purchased by another user different from the user is computed, and the first search query group is judged to be the non-target search query group if the similarity is greater than or equal to a threshold.

### Supplementary Note 20

With the computer-readable recording medium according to supplementary note 17, in the step (d), user information of a user who has input at least a predetermined number of first search query groups that were distinguished as being the target search query group is extracted.

### Supplementary Note 21

With the computer-readable recording medium according to supplementary note 15, in the step (c), in a case where there are a plurality of first search query groups, the similarity to the keyword group is computed sequentially from the first search query group whose search date-time is closest to a purchase date-time.

Although the present invention has been described above with reference to embodiments, the invention is not limited to these embodiments. A person skilled in the art will appreciate that the configuration and details of the invention can be variously modified within the scope of the invention.

This application claims priority from Japanese Patent Application No. 2012-096400 filed on Apr. 20, 2012, the entire disclosure of which is herein incorporated by reference.

### INDUSTRIAL APPLICABILITY

According to the present invention as described above, search queries can be analyzed in order to uncover a new application of a product. The present invention is thus useful in shopping site systems and the like.

### DESCRIPTION OF REFERENCE NUMERALS

1 Search query analysis device
12 Keyword extraction unit
13 Search query sorting unit
14 Search query group extraction unit
15 Search query group distinguishing unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A search query analysis device comprising:
a search query sorting unit that sorts a plurality of search queries input by a user into a plurality of search query groups in chronological order, and specifies a purchase search query group that includes a search query input immediately before a product purchase of the user and first search query groups input before the purchase search query group, among the plurality of search query groups;
a keyword extraction unit that extracts a keyword group from a description of a purchased product purchased by the user; and
a search query group extraction unit that computes a similarity between the first search query groups and the keyword group extracted by the keyword extraction unit, and extracts a first search query group whose similarity is less than a threshold.

2. The search query analysis device according to claim 1,
wherein the search query sorting unit sorts the plurality of search queries into the plurality of search query groups based on a similarity between the search queries.

3. The search query analysis device according to claim 1, further comprising:
a search query group distinguishing unit for distinguishing the first search query group extracted by the search query group extraction unit as being a target search query group directed to searching for the purchased product or a non-target search query group not directed to searching for the purchased product.

4. The search query analysis device according to claim 3,
wherein the search query group distinguishing unit computes a similarity between the first search query group extracted by the search query group extraction unit and a second search query group input after the purchase search query group, and judges the first search query group to be the non-target search query group if the similarity is greater than a threshold.

5. The search query analysis device according to claim 3,
wherein the search query group distinguishing unit computes a similarity between the first search query group extracted by the search query group extraction unit and a purchase search query group used when another product different from the purchased product was purchased by another user different from the user, and judges that the first search query group is the non-target search query group if the similarity is greater than or equal to a threshold.

6. The search query analysis device according to claim 3,
wherein the search query group distinguishing unit extracts user information of a user who has input at least a predetermined number of first search query groups that were distinguished as being the target search query group.

7. The search query analysis device according to claim 1,
wherein the search query group extraction unit, in a case where there are a plurality of first search query groups, computes the similarity to the keyword group sequentially from the first search query group whose search date-time is closest to a purchase date-time.

8. A search query analysis method comprising the steps of:
(a) sorting a plurality of search queries input by a user into a plurality of search query groups in chronological order, and specifying a purchase search query group that includes a search query input immediately before a product purchase of the user and first search query groups input before the purchase search query group, among the plurality of search query groups;
(b) extracting a keyword group from a description of a purchased product purchased by the user; and
(c) computing a similarity between the first search query groups and the keyword group extracted in the step (b), and extracting a first search query group whose similarity is less than a threshold.

9. The search query analysis method according to claim 8,
wherein, in the step (a), the plurality of search queries are sorted into the plurality of search query groups based on a similarity between the search queries.

10. The search query analysis method according to claim 8, further comprising the step of:
(d) distinguishing the first search query group extracted in the step (c) as being a target search query group directed to searching for the purchased product or a non-target search query group not directed to searching for the purchased product.

11. The search query analysis method according to claim 10,
wherein, in the step (d), a similarity between the first search query group extracted in the step (c) and a second search query group input after the purchase search query group is computed, and the first search query group is judged to be the non-target search query group if the similarity is greater than a threshold.

12. The search query analysis method according to claim 10,
wherein, in the step (d), a similarity between the first search query group extracted in the step (c) and a purchase search query group used when another product different from the purchased product was purchased by another user different from the user is computed, and the first search query group is judged to be the non-target search query group if the similarity is greater than or equal to a threshold.

13. The search query analysis method according to claim 10,
wherein, in the step (d), user information of a user who has input at least a predetermined number of first search query groups that were distinguished as being the target search query group is extracted.

14. The search query analysis method according to claim 8,
wherein, in the step (c), in a case where there are a plurality of first search query groups, the similarity to the keyword group is computed sequentially from the first search query group whose search date-time is closest to a purchase date-time.

15. A computer-readable recording medium storing a computer program for analyzing, by computer, a search query input by a user, the computer program including commands for causing the computer to execute the steps of:
(a) sorting a plurality of search queries input by a user into a plurality of search query groups in chronological order, and specifying a purchase search query group that includes a search query input immediately before a product purchase of the user and first search query groups input before the purchase search query group, among the plurality of search query groups;
(b) extracting a keyword group from a description of a purchased product purchased by the user; and
(c) computing a similarity between the first search query groups and the keyword group extracted in the step (b), and extracting a first search query group whose similarity is less than a threshold.

16. The computer-readable recording medium according to claim 15,
wherein, in the step (a), the plurality of search queries are sorted into the plurality of search query groups based on a similarity between the search queries.

17. The computer-readable recording medium according to claim 15, wherein the computer program further includes a command for causing the computer to execute the step of:
(d) distinguishing the first search query group extracted in the step (c) as being a target search query group directed to searching for the purchased product or a non-target search query group not directed to searching for the purchased product.

18. The computer-readable recording medium according to claim 17,
wherein, in the step (d), a similarity between the first search query group extracted in the step (c) and a second search query group input after the purchase search query group is computed, and the first search query group is judged to be the non-target search query group if the similarity is greater than a threshold.

19. The computer-readable recording medium according to claim 17,
wherein, in the step (d), a similarity between the first search query group extracted in the step (c) and a purchase search query group used when another product different from the purchased product was purchased by another user different from the user is computed, and the first search query group is judged to be the non-target search query group if the similarity is greater than or equal to a threshold.

20. The computer-readable recording medium according to claim 17,
wherein, in the step (d), user information of a user who has input at least a predetermined number of first search query groups that were distinguished as being the target search query group is extracted.

21. The computer-readable recording medium according to claim 15,
wherein, in the step (c), in a case where there are a plurality of first search query groups, the similarity to the keyword group is computed sequentially from the first search query group whose search date-time is closest to a purchase date-time.
